(19) United States
(12) Patent Application Publication
(10) Pub. No.: US 2004/0240845 A1
(43) Pub. Date: Dec. 2, 2004

(54) Apparatus and method for editing motion picture, and recording medium in which computer executable program is recorded

(75) Inventor: Tetsuya Hayashi, Hanno-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/851,881

(22) Filed: May 20, 2004

(30) Foreign Application Priority Data
May 30, 2003 (JP) 2003-154199

(51) Int. Cl. H04N 5/76; G11B 27/00

(52) U.S. Cl. 386/52; 386/64

(57) ABSTRACT

The present invention relates to edition of motion picture data and produces desired results using precise settings while allowing an editing apparatus to be easily operated. The present apparatus includes a memory card or a built-in memory which stores motion picture data, a display section which displays an image, and a control section which reproduces the stored motion picture data to display the reproduced data on the display section and which operates in response to an input from a key input section instructing on an edition point position at an arbitrary time during reproduction of a motion picture, to use the edition point position as a base point to store an amount of the motion picture data corresponding to a predetermined time.

### CROSS-REFERENCE TO RELATED APPLICATIONS

This application is based upon and claims the benefit of priority from prior Japanese Patent Application No. 2003-154199, filed May 30, 2003, the entire contents of which are incorporated herein by reference.

### BACKGROUND OF THE INVENTION

1. Field of the Invention

The present invention relates to an apparatus and method for editing a motion picture which apparatus and method are suitable for a digital camera, a cellular phone terminal with a camera function, or the like, as well as a recording medium in which a computer executable program is recorded.

2. Description of the Related Art

Instead of cameras employing silver films, digital cameras have recently been commonly used. Digital cameras enable photographed contents to be immediately reproduced by converting a photographed image into electronic data and storing the data in a storage medium such as a memory card.

Most digital cameras enable photographing of not only still images but also motion pictures each composed of a plurality of temporally successive still images, though the latter is limited in terms of the number of constituent pixels, the number of images per unit time, a continuous photographing time, and the like.

Normally, a data file of motion pictures photographed using a digital camera is generally loaded into a personal computer and edited using video editing software.

To allow motion picture data to be easily edited using only a digital camera, proposals have been made to use an edition point instructed on at an arbitrary time during reproduction, as a reference to delete the part of the data preceding or succeeding the edition point, divide the data into these parts, or connect these parts together (for example, Patent Document 1).

[Patent Document 1]

Jpn. Pat. Appln. KOKAI Publication No. 11-275512

However, most video editing software used in personal computers are products intended for DV cameras using a DV (Digital Video) tape as a storage medium. Accordingly, most of them do not deal with motion picture data photographed using a digital (still) camera inherently used to photograph still images.

### BRIEF SUMMARY OF THE INVENTION

An aspect of the present invention is characterized by comprising a storage section which stores motion picture data, a display section which displays an image, a motion picture reproducing section which reproduces the motion picture data stored in the storage section to display the reproduced data on the display section, a position instructing section which instructs on an edition point position at an arbitrary time while the motion picture reproducing section is reproducing a motion picture, and an editing section which uses the edition point position instructed on by the position instructing section as a base point to store an amount of the motion picture data corresponding to a predetermined time in the storage section as new motion picture data.

Another aspect of the present invention is characterized by comprising a storage section which stores motion picture data, a display section which displays an image, a motion picture reproducing section which reproduces the motion picture data stored in the storage section to display the reproduced data on the display section, a first position instructing section which instructs on a first edition point position at an arbitrary time while the motion picture reproducing section is reproducing a motion picture, a second position instructing section which operates after the instruction has been given by the first position instructing section, to instruct on a second edition point position at an arbitrary time, and an editing section which stores a part of the motion picture data in the storage section as new motion picture data on the basis of the first and second edition point positions instructed on by the first and second position instructing sections, respectively.

Another aspect of the present invention is characterized by comprising a storage section which stores motion picture data, a display section which displays an image, a motion picture reproducing section which reproduces the motion picture data stored in the storage section to display the reproduced data on the display section, a position instructing section which instructs on an edition point position at an arbitrary time while the motion picture reproducing section is reproducing a motion picture, and an editing section which divides the motion picture data on the basis of the edition point position instructed on by the position instructing section to store each of the motion picture data preceding the edition point position and the motion picture data succeeding the edition point position in the storage section as new motion picture data.

### BRIEF DESCRIPTION OF THE SEVERAL VIEWS OF THE DRAWING

FIGS. 1A and 1B are perspective views showing the external configuration of a digital camera according to a first embodiment of the present invention;

FIG. 2 is a block diagram showing the configuration of an electronic circuit in a digital circuit according to the first embodiment;

FIG. 3 is a flow chart showing the contents of processing in a reproduction mode, particularly in a motion picture editing mode according to the first embodiment;

FIGS. 4A to 4C are views illustrating the transition of a display screen in the motion picture edition mode according to the first embodiment;

FIGS. 5A to 5C are diagrams illustrating correspondences between edition timings for motion picture data and newly created motion picture data according to the first embodiment;

FIGS. 6A to 6C are diagrams illustrating correspondences between edition timings for motion picture data and newly created motion picture data according to the first embodiment;

FIGS. 7A and 7B are perspective views showing the external configuration of a cellular phone terminal according to a second embodiment of the present invention;

FIG. 8 is a block diagram showing the configuration of an electronic circuit in a cellular phone according to the second embodiment;

FIG. 9 is a flow chart showing the contents of processing in a reproduction mode, particularly in a motion picture edition mode according to the second embodiment;

FIGS. 10A to 10C are diagrams illustrating correspondences between edition timings for motion picture data and newly created motion picture data according to the second embodiment;

FIG. 11 is a flow chart showing the contents of processing in a reproduction mode, particularly in a motion picture edition mode according to a third embodiment; and

FIGS. 12A to 12D are diagrams illustrating correspondences between edition timings for motion picture data and newly created motion picture data according to the third embodiment.

### DETAILED DESCRIPTION OF THE INVENTION

### FIRST EMBODIMENT

With reference to the drawings, description will be given below of a first embodiment in which the present invention is applied to a digital camera.

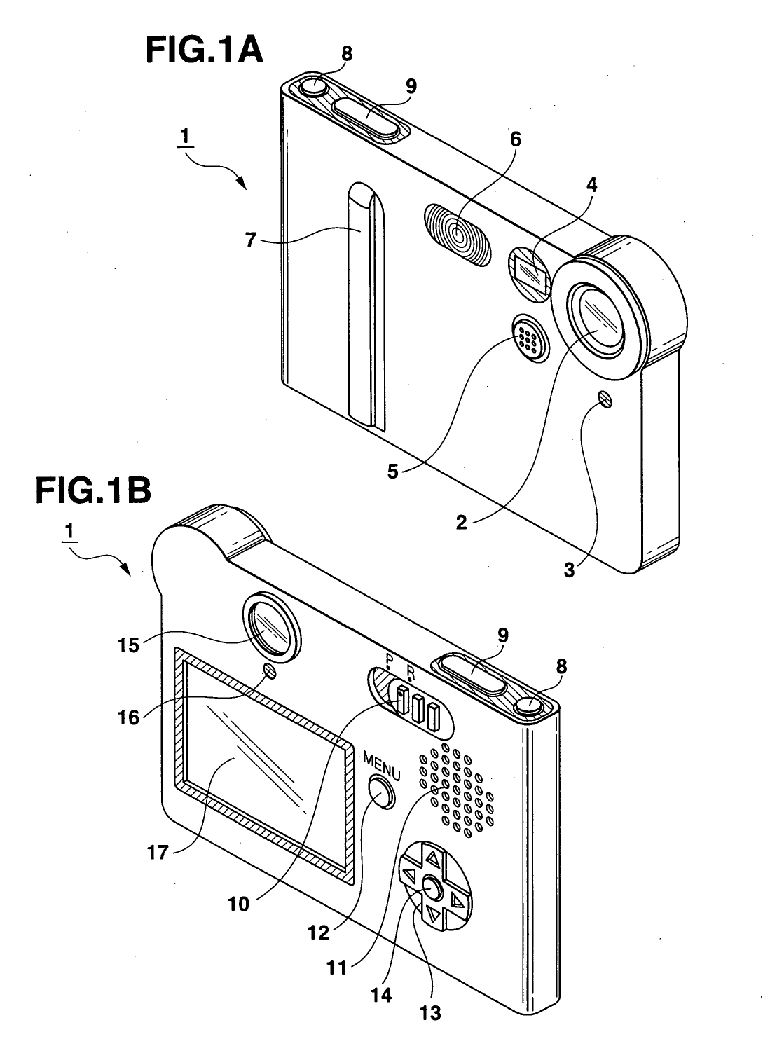

FIGS. 1A and 1B both show the external configuration of the digital camera. FIG. 1A is a perspective view mainly showing a front surface of the digital camera. FIG. 1B is a perspective view mainly showing a rear surface of the digital camera.

The digital camera 1 has a photographing lens 2, a self timer lamp 3, an optical finder window 4, a microphone section 5, a strobe light emitting section 6, and a rubber grip 7 disposed on a front surface of a generally rectangular thin-plate body, and a power key 8 and a shutter key 9 (position instructing section, first position instructing section, and second position instructing section) disposed at a right end (as viewed from a user) of a top surface of the body.

The rubber grip 7 is a band-like projection made of rubber and disposed so that when the user grips the digital camera 1 with his or her right hand from a right-hand surface of a housing for photographing, the middle finger, ring finger, and little finger of his or her right hand can reliably grip the housing.

The power key 8 is operated to turn a power on or off.

The digital camera 1 has a mode switch (SW) 10, a speaker section 11, a menu key 12, a cross key 13 (a timing instructing section), a set key 14 (a timing instructing section), an optical finder 15, and a strobe charge lamp 16, and a display section 17 disposed on its rear surface.

The mode switch 10 is composed of, for example, a slide key switch to switch between a record mode “R” and a play mode “P”, which are basic modes.

The menu key 12 is operated to select any menu item.

The cross key 13 is composed of a key used to move a cursor upward, downward, rightward, and leftward. The cross key 13 is operated to move a displayed menu item or the like.

The set key 14 is placed at a central position on the cross key 13. The set key 14 is operated to set, for example, the contents of a menu item selected at that point.

The strobe charge lamp 16 is composed of an LED lamp placed close to the optical finder 15. The strobe charge lamp 16-allows the user to view the charged state of a strobe whether the user is looking through the optical finder 15 or viewing the display section 17.

The display section 17 is composed of a color liquid crystal panel with a backlight. The display section 17 operates as an electric finder to provide a monitor display of a through image in the record mode, and reproduces and displays a selected image or the like in the play mode.

Although not shown, a bottom surface of the digital camera 1 is provided with a memory card slot into and from which a memory card used as a recording medium (storage section) is installed and removed, and for example, a USB (Universal Serial Bus) connector operating as a serial interface connector connected to an external personal computer or the like.

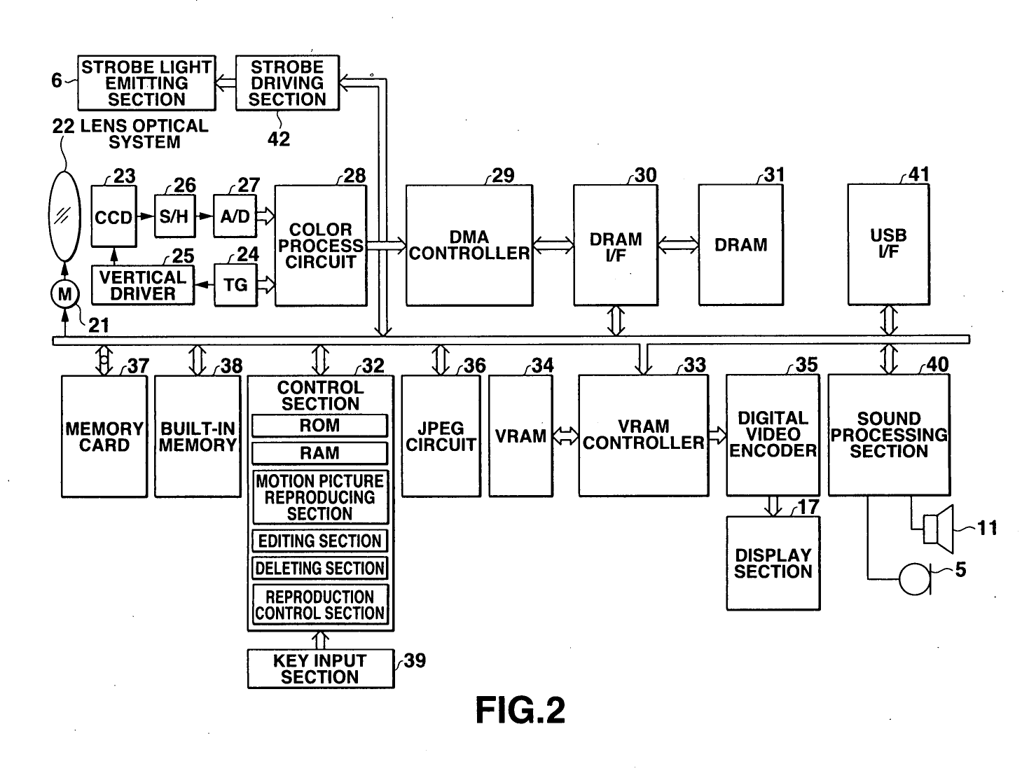

The configuration of an electronic circuit in the digital camera 1 will be described with reference to FIG. 2.

In this figure, in the record mode, a basic mode, a motor (M) 21 executes driving to move a focusing or stopping position of a lens optical system 22 constituting the photographing lens 2. A CCD 23 that is a photographing element is placed behind a photographing optical axis of the lens optical system 22. The CCD 23 is driven by a timing generator (TG) 24 and a vertical driver 25 for scanning to output a photoelectric conversion output for one screen corresponding to an optical image formed every fixed period.

As a signal with an analog value, the photoelectric conversion output has its gain properly adjusted for each primary color component. Then, a sample hold circuit (S/H) 26 samples and holds the output, and an A/D converter 27 converts it into digital data and transmits the digital data to a color process circuit 28. The color process circuit 28 executes a color process including a pixel interpolating process and a γ correcting process to generate a luminance signal Y and a color difference signals Cb and Cr with digital values. The color process circuit 28 then outputs these signals to a DMA (Direct Memory Access) controller 29.

The DMA controller 29 writes the luminance signal Y and color difference signals Cb and Cr outputted by the color process circuit, in a buffer provided inside the DMA controller 29, using a composite synchronous signal, a memory write enable signal, and a clock signal also provided by the color process circuit 28. The DMA controller 29 then DMA-transfers the luminance signal Y and color difference signals Cb and Cr to a DRAM 31 via a DRAM interface (I/F) 30. The DRAM 31 is used as a buffer memory.

A control section 32 is composed of a ROM that fixedly stores an operation program that executes a process for an operation of the shutter key 9 in the record mode, described later, a RAM used as a work memory, and the like. The control section performs control operations for the whole digital camera 1 and also operates as a motion picture reproducing section, an editing section, a deleting section, and a reproduction control section.

After the DMA transfer of the luminance and color difference signals to the DRAM 31 has been finished, the control section 32 reads these signals from the DRAM 31 via the DRAM interface 30. The control section 32 then writes these signals in a VRAM 34 via a VRAM controller 33.

A digital video encoder 35 periodically reads the luminance and color difference signals from the VRAM 34 via the VRAM controller 33. The digital video encoder 35 then generates a video signal on the basis of these data and outputs the signal to the display section 17.

The display section 11 functions as a monitor display section (electronic finder) in the record mode as described above. The display section 17 provides a display based on the video signal from the digital video encoder 35 to display an image based on image information loaded from the VRAM controller 33 at that point.

With the image at that point displayed on the display section 17 in real time, the shutter key 9 is operated when a still image is to be photographed. Then, a trigger signal is generated.

In response to the trigger signal, the control section 32 DMA-transfers an amount of luminance and color difference signals already loaded from the CCD 23 and corresponding to one screen, to the DRAM 31. The control section 32 then immediately stops a path from the CCD 23 to the DRAM 31 to shift to a record saving state.

In the record saving state, the control section 32 sequentially reads an amount of luminance and color difference signals written in the DRAM 31 and corresponding to one frame, via the DRAM interface 30 so that a component Y, Cb, or Cr is read each time by a unit amount called a basic block of 8×8 pixels. The control section 32 then writes these signals to a JPEG (Joint Photograph coding Experts Group) circuit 36.

The JPEG circuit 36 executes processes such as an ADCT (Adaptive Discrete Cosine Transform) and a Huffman coding that is an Entropy coding method, to compress the data.

The control section 32 reads the code data obtained from the JPEG circuit 36 to obtain a data file for one image. The control section 32 then writes the data file in either a removably installed memory card 37 that is a storage section of the digital camera 1 or a fixedly built-in memory 38 that is also a storage section of the digital camera 1.

After all the luminance and color difference signals for one frame have been compressed and all the compressed data has been written in the memory card 37 or built-in memory 38, the control section 32 activates the path from the CCD 23 to the DRAM 31 again.

Further, the control section 32 connects to a key input section 39, a sound processing section 40, a USB interface (I/F) 41, and a strobe driving section 42.

The key input section 39 is composed of the above described shutter key 9, power key 8, mode switch 10, menu key 12, cross key 13, set key 14, and the like. A signal generated by operating any of these keys is dispatched directly to the control section 32.

The sound processing section 40 comprises a sound source circuit such as a PCM sound source. To record a sound, the sound processing section 40 converts a sound signal inputted by the microphone section (MIC) 5 into digital data. The sound processing section 40 then compresses the data in accordance with a predetermined data file format, for example, the MP3 (MPEG-1 audio layer 3) to create a sound data file. The sound processing section 40 subsequently dispatches the compressed data to the sound data file to the memory card 37 or the built-in memory 38.

On the other hand, to reproduce a sound, the sound processing section 40 decompresses a sound data file transmitted from the memory card 37 or the built-in memory 38, into analog data. The sound processing section 40 then drives the speaker section (SP) to amplify and emit the sound.

The USB interface 41 controls communication if image data or the like is transmitted to or received from another information terminal apparatus such as a personal computer connected by wire via a USB connector.

The strobe driving section 42 charges a bulk capacitor for a strobe (not shown) before a still image is to be photographed. The strobe driving section 42 drivingly flashes the strobe light emitting section 6 on the basis of control by the control section 32.

On the other hand, when a motion picture is photographed instead of a still image, while the shutter key 9 remains operated, still image data files in the memory card 37 or built-in memory 38 are temporally continuously recorded, the still image data file being obtained by the JPEG circuit 36 by compressing the above still image data. Once the operation of the shutter key 9 has been finished or a predetermined time limit, for example, 30 seconds have elapsed, the control section 32 re-sets the series of still image data files into a motion JPEG data file (AVI file).

Furthermore, in the play mode, a basic mode, the control section 32 selectively reads the image data recorded in the memory card 37 or built-in memory 38. The JPEG circuit 36 then decompresses the compressed image data using a reverse procedure to that used for data compression in the record mode. Then, the decompressed image is retained in the DRAM 31 via the DRAM interface 30. The contents retained by the DRAM 31 are then stored in the VRAM 34 via the VRAM controller 33. The image data is periodically read from the VRAM 34 to generate a video signal. The display section 17 then reproduces and outputs the video signal.

If selected image data is not a still image but a motion picture, individual still image data constituting the selected motion picture file is temporally continuously reproduced. Once all the still image data has been reproduced, an image is reproduced and displayed using only the leading still image data until the next instruction on reproduction is given.

Operations of the above embodiment will be described below.

Basically, the control section 32 executes the processes shown below on the basis of a pre-stored program.

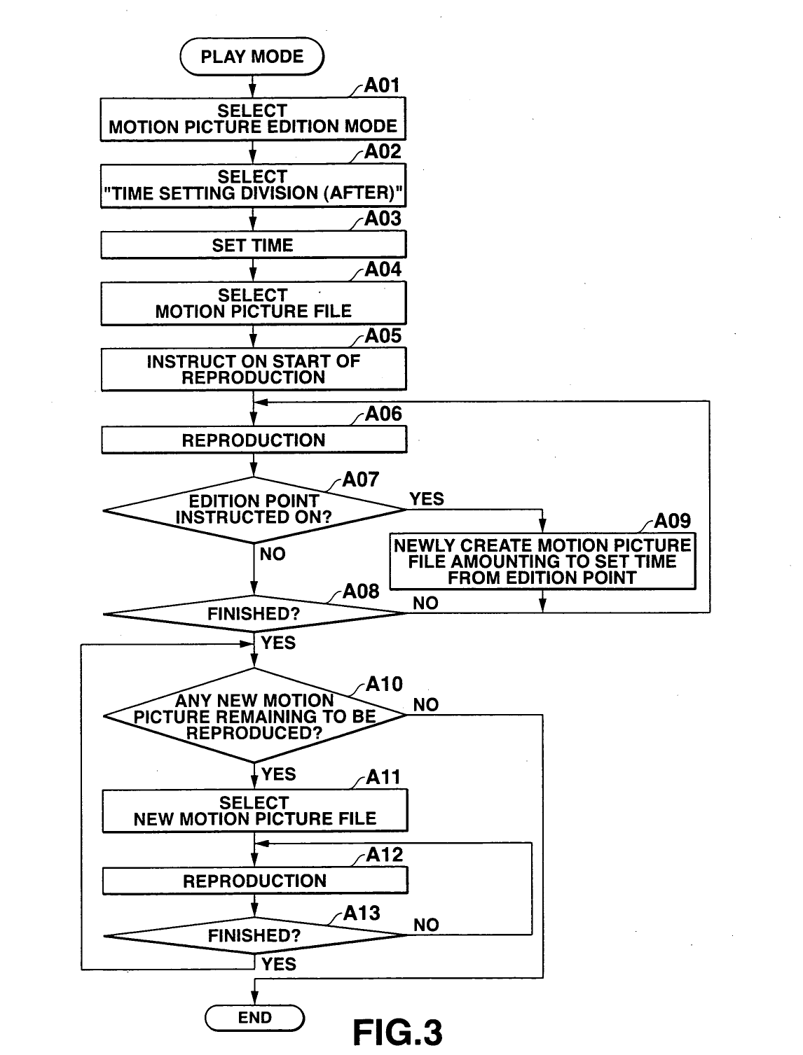

FIG. 3 shows the contents of processing executed in the play mode. First, in the play mode, for example, the menu key 12, the cross key 13, and the set key 14 are operated to select a menu item for a motion picture edition mode (step A01).

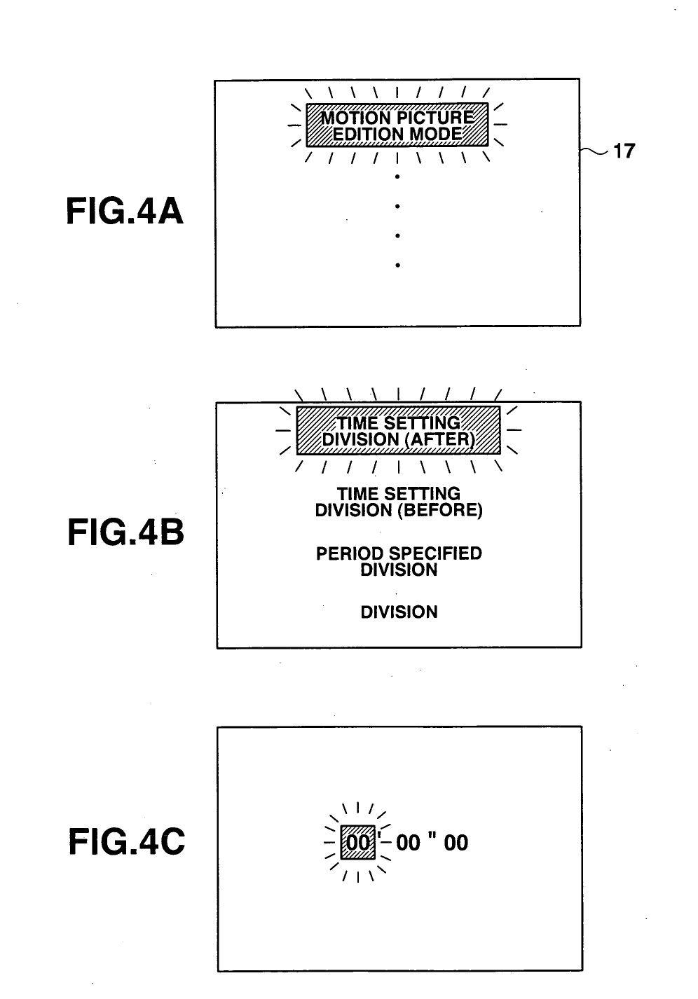

FIG. 4A shows that the “motion picture edition mode”, displayed on the display section 17 together with other menu items, is selected as a menu item. At this time, the characters of “motion picture edition mode” are reversed and blinked so as to be distinguished from the other menu items. With this menu item selected, the set key 14 is operated to establish the “motion picture edition mode”.

FIG. 4B illustrates a screen on the display section 17 which lists items for editing methods any of which is selected to determine a specific manner of editing data in the motion picture edition mode.

In this case, the editing method can be selected from at least four items, for example, “time setting division (after)”, “time setting division (before)”, “period specified division”, and “division”.

Here, the “time setting division (after)” is an editing method of setting an arbitrary edition point position in motion picture data as a start point to extract a portion succeeding the start point and extending over a temporal width arbitrarily set by the user, and storing the portion as another new motion picture data.

The “time setting division (before)” is an editing method of setting an arbitrary edition point position in motion picture data as an end point to extract a portion preceding the end point and extending over a temporal width arbitrarily set by the user, and storing the portion as another new motion picture data.

The “period specified division” is an editing method of setting two arbitrary edition point positions in motion picture data as a start and end points to extract a portion located between these two edition point positions, and storing the portion as another new motion picture data.

The “division” is an editing method of setting an arbitrary edition point position in motion picture data as a division point to extract portions preceding and succeeding the division point, and storing each portion as another new motion picture data.

When the “time setting division (after)” is selected from these editing methods and set (step A02), the display section 17 displays a screen on which a time for motion picture data to be extracted is then arbitrarily set.

FIG. 4C illustrates a time setting screen displayed on the display section 17 at this time.

FIG. 4C shows that a numerical value is set for a “minute” unit. The cross key 13 and the set key 14 are operated to set the “minute” value. Subsequently, a “second” value and a “sub-second” value are set to finish the time setting (step A03).

Subsequently, a motion picture to be edited is selected (step A04). The appropriate key is operated to instruct the reproduction of the motion picture data to be started (step A05). Then, the selected motion picture data is reproduced from its leading position (step A06). It is repeatedly determined whether or not an edition point position has been instructed on by, for example, operating the shutter key 9 (step A07) and whether or not all the motion picture data has been reproduced (step A08). Thus, the procedure waits until an edition point position is instructed on or the reproduction is finished.

Then, if an edition point position has been instructed on by operating the shutter key 9, this is confirmed in a step A07 and then the specified edition point position is set as a start point. Then, motion picture data is extracted (copied) which succeeds the start point and which extends over the temporal width set in the step A03. This data is formed into another motion picture data, which is newly stored and saved in the memory card 37 or the built-in memory 38 (step A09). The procedure then returns to the process starting at the step A06.

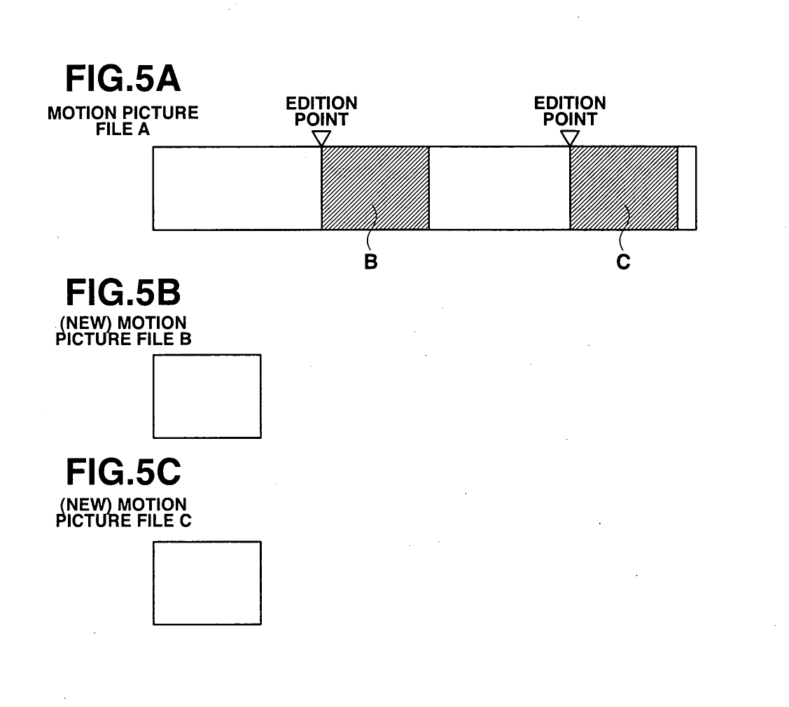

FIG. 5A illustrates original motion picture data A to be edited. It is assumed that while this motion picture data is being reproduced, two edition point positions are instructed on as shown in the figure.

Accordingly, the first specified edition point position is used as a start point to extract contents amounting to the set time. These contents are stored as a new motion picture file B as shown in FIG. 5B. On the other hand, the second specified edition point position is used as a start point to extract contents amounting to the set time. These contents are stored as a new motion picture file C as shown in FIG. 5C.

Once all the motion picture data has been reproduced, this is confirmed in a step A08 and it is then determined whether or not all the new motion picture data created in connection with the instructions on the edition point positions during the reproduction of the motion picture data has been automatically reproduced (step A10).

If during the reproduction of the motion picture data, no edition point positions have been instructed on by operating the shutter key 9, the series of processes are ended by assuming that there is no corresponding new motion picture data at this point.

On the other hand, if it is determined in the step A10 that there yet remains new motion picture data to be automatically reproduced, one of the new motion picture data is selected in accordance with the order in which, for example, the edition point positions were instructed on (step A11).

Then, the selected new motion picture data is automatically reproduced (step A12). The procedure waits until the reproduction is finished (step A13). Once it is determined that the reproduction has been finished, the procedure returns to the process starting at the step A10.

Thus, all the motion picture data newly created in accordance with the instructions on the edition point positions is automatically repeatedly reproduced after the reproduction of the original motion picture data. Once all the new motion picture data has been automatically reproduced, this is confirmed in the step A10 to end the series of processes.

In the description of the above embodiment, another new motion picture data is created by setting the specified edition point position as a start point to extract the motion picture data succeeding the start point and extending over a distance equal to the set time on a temporal axis. However, another new motion picture data may be created by setting the specified edition point position as an end point to extract the motion picture data preceding the start point and extending over a distance equal to the set time on the temporal axis.

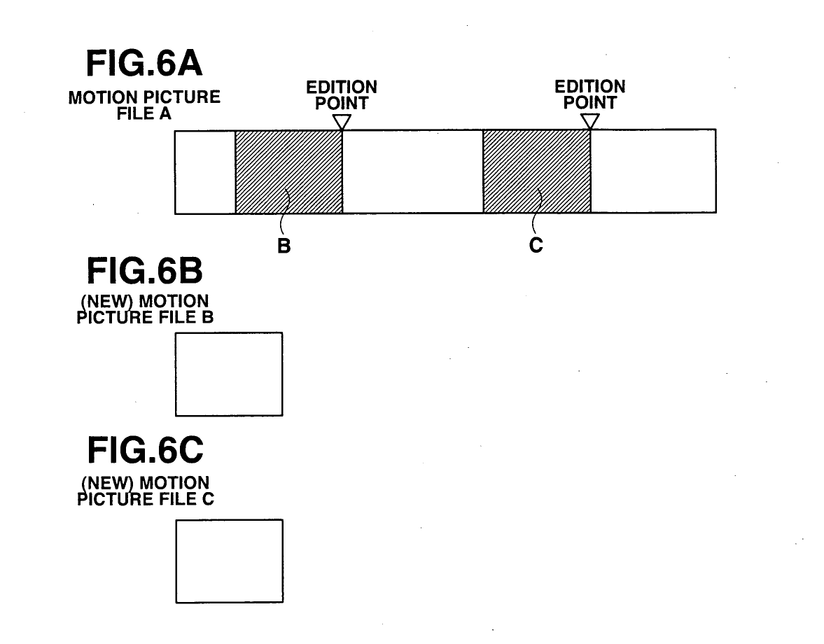

FIG. 6A illustrates an original motion picture data A to be edited if a motion picture is edited as described above. It is assumed that while this motion picture data is being reproduced, two editing point positions are instructed, as shown in the figure.

Accordingly, the first specified edition point position is used as an end point to extract contents preceding the end point and amounting to the set time. These contents are stored as a new motion picture file B as shown in FIG. 6B. On the other hand, the second specified edition point position is used as an end point to extract contents preceding the end point and amounting to the set time. These contents are stored as a new motion picture file C as shown in FIG. 6C.

In this manner, new motion picture data different from the original motion picture data is created by setting a specified edition point position as a base point to extract (copy) motion picture data amounting to a predetermined time. Consequently, new motion picture data can be created only by a simple operation of instructing on timings for edition points to extract data amounting to a predetermined time, without impairing the original motion picture data.

In this case, a time lag for the operation for the edition point may be allowed, for example, a total of 10 seconds including 2 seconds before and 8 seconds after the operation for the instruction on the edition point position. Thus, a predetermined time may be set before and after the edition point. However, when new motion picture data is created simply by instructing on a timing for the start or end point of the required predetermined time as in the case of the above embodiment, it is possible to instruct on the edition point so as to make the user understand the operation more easily.

Further, the time for newly created motion picture data can be arbitrarily preset. Accordingly, the user can instruct on the time for the motion picture data newly created by himself or herself. This makes it possible to perform more appropriate and efficient editing operations.

The time for new motion picture data may be set before the instruction on the edition point as described in the above embodiment. Alternatively, time values corresponding to individual motion picture data may be arbitrarily set after the instruction on the edition point.

Furthermore, in the above embodiment, after the original motion picture data has been reproduced, newly created motion picture data is automatically sequentially reproduced. It is thus possible to immediately check the contents of the newly created motion picture data and to promptly deal with problems with the contents.

### SECOND EMBODIMENT

With reference to the drawings, description will be given below of a second embodiment in which the present invention is applied to a cellular phone with a camera function based on a CDMA (Code Division Multiple Access) system.

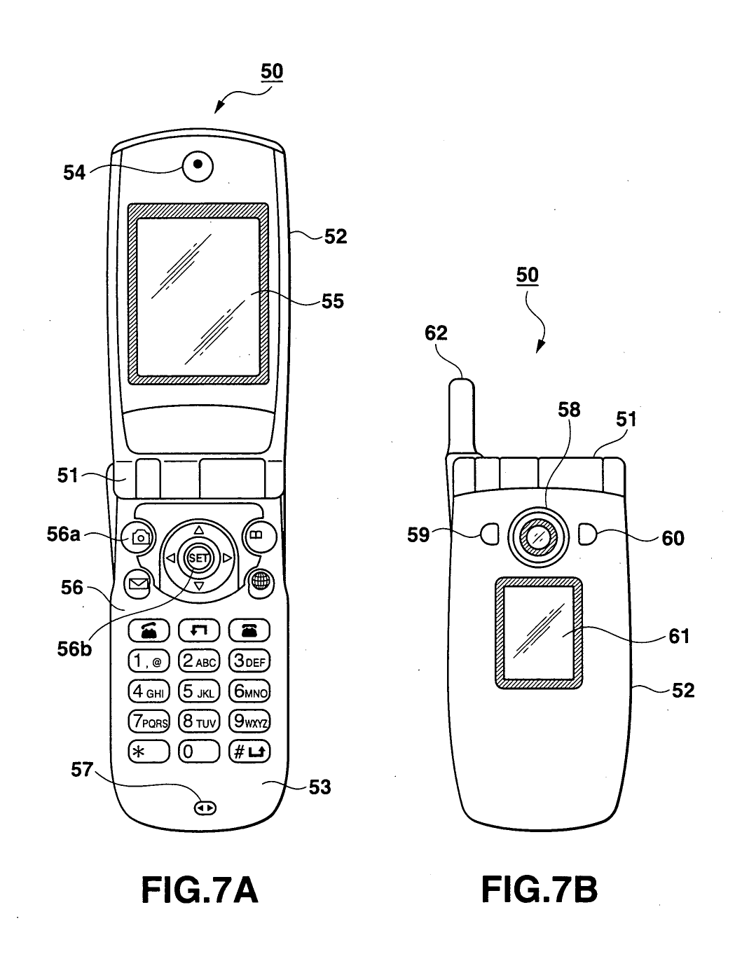

FIGS. 7A and 7B show the external configuration of a cellular phone 50 according to the second embodiment. Two housings 52 and 53 are integrated together via a hinge portion 51 so as to be folded up. FIG. 7A shows an inner surface of the maximally opened cellular phone. FIG. 7B shows an outer surface mainly of the upper housing 52 of the folded cellular phone.

As shown in FIG. 7A, the inner surface of the upper housing 52 is provided with a speaker 54 acting as a receiver, and a main display section 55 (display section).

The inner surface of the lower housing 53 is provided with various keys 56 including a dial key and a microphone 57 acting as a transmitter.

As shown in FIG. 7B, the outer surface of the upper housing 52 is provided with a camera section 58, a photographing light 59, a shutter key 60, and a sub-display section 61 (display section). Moreover, an antenna 62 extended into the lower housing 53 is formed to project from the hinge portion 51.

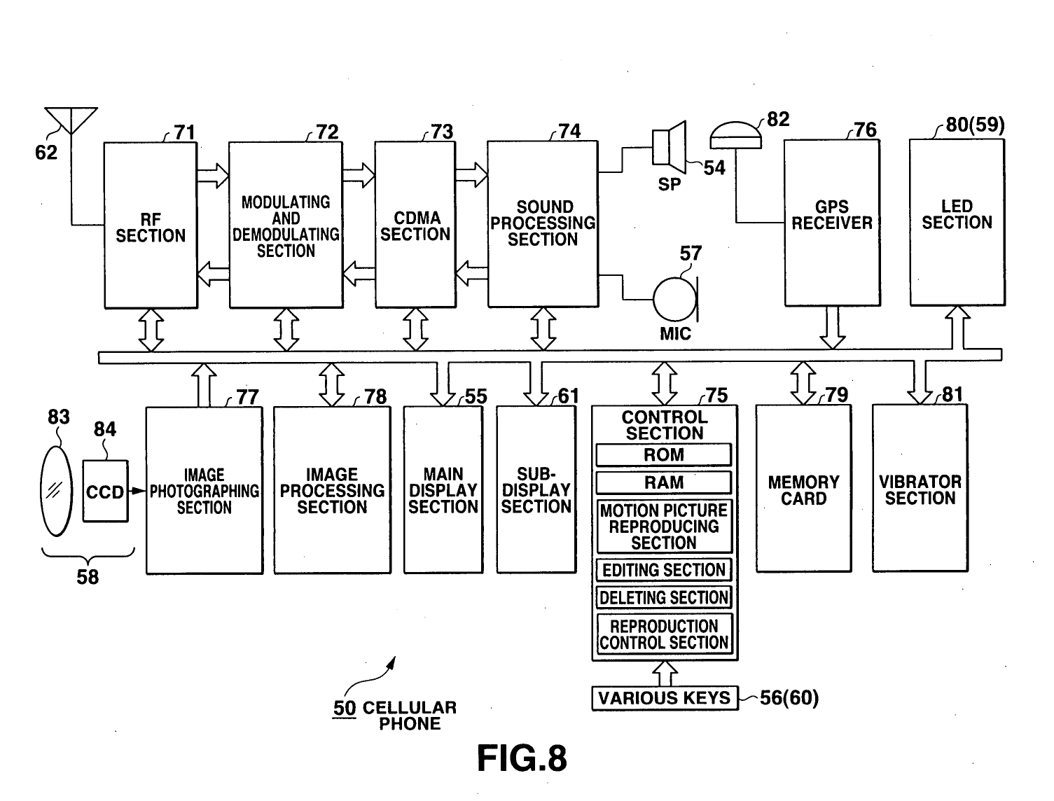

FIG. 8 shows the configuration of a circuit in the cellular phone 50. In this figure, the antenna 62 communicates with the nearest base station on the basis of the CDMA system. An RF section 71 is connected to the antenna 62.

Upon receiving a signal inputted from the antenna 62, the RF section 71 uses a duplexer to separate the signal from a frequency axis and mixes it with a local oscillation signal of a predetermined frequency outputted by a PLL synthesizer to convert its frequency to obtain an IF signal. The RF section 71 further uses a wide-band BPF to extract only a reception frequency channel and then uses an AGC amplifier to adjust the signal level of a desired reception wave to a specified value. The RF section 71 then outputs the resultant signal to a modulating and demodulating section 72 succeeding the RF section 71.

On the other hand, for transmission, the RF section 71 uses the AGC amplifier to control the transmission power of an OQPSK (Offset Quadri-Phase Shift Keying) modulated signal on the basis of control by a control section 75, described later. The RF section 71 then mixes the signal with a local oscillation signal of a predetermined frequency outputted by the PLL synthesizer to convert its frequency into an RF band. The RF section 71 then uses a PA (Power Amplifier) to amplify the signal to increase its power. The RF section 71 then radiates and transmits the resultant signal from the antenna 62 via the duplexer.

Upon receiving an IF signal from the RF section 71, the modulating and demodulating section 72 uses an orthogonal detector to separate the IF signal into a base band I/Q (In-phase/Quadrature-phase) signal. The modulating and demodulating section 72 digitalizes the I/Q signal and outputs the digitalized signal to a CDMA section 73.

On the other hand, for transmission, the modulating and demodulating section 72 converts an I/Q signal with a digital value from the CDMA section 73 into an analog signal. The modulating and demodulating section 72 then uses the orthogonal detector to subject the signal to OQPSK modulation. The modulating and demodulating section 72 then dispatches the modulated signal to the RF section 71.

Upon receiving a digital signal from the modulating and demodulating section 72, the CDMA section 73 inputs the digital signal to a plurality of demodulating circuits that execute back diffusion and demodulation in accordance with instructions from a timing extracting circuit for a PN (Pseudo Noise) code and its timing circuit. The CDMA section 73 synchronizes a plurality of demodulation symbols from the demodulating circuits. The CDMA section 73 then uses a synthesizer to synthesize the symbols to one another and outputs them to a sound processing section 74.

On the other hand, for transmission, the CDMA section 73 diffuses an output symbol from the sound processing section 74. The CDMA section 73 then uses a digital filter to subjects the symbol to a band restriction to obtain an I/Q signal. The CDMA-section 73 then outputs the I/Q signal to the modulating and demodulating section 72.

Upon receiving an output symbol from the CDMA section 73, the sound processing section 74 deinterleaves the output symbol. The sound processing section 74 then uses a Viterbi demodulator to subject the symbol to an error correcting process. The sound processing section 74 subsequently decompresses the digital signal compressed by a sound processing DSP (Digital Signal Processor) into a normal digital sound signal. The sound processing section 74 further converts the digital sound signal into an analog signal and drives the speaker (SP) 54.

On the other hand, for transmission, the sound processing section 74 converts an analog sound signal inputted by the microphone (MIC) 57, into a digital signal. The sound processing section 74 then uses the sound processing DSP to carry out compression to reduce the amount of data. The sound processing section 74 then uses a convolution encoder to correct errors in the data and encode it. The sound processing section 74 subsequently interleaves the encoded data and dispatches its output symbol to the CDMA section 73.

Then, the control section 75 is connected to the RF section 71, modulating and demodulating section 72, CDMA section 73, and sound processing section 74. The control section 75 is also connected to a GPS receiver 76, an image photographing section 77, an image processing section 78, the main display section 55, the sub-display section 61, a memory card 79, a LED section 80, and a vibrator section 81.

The control section 75 is composed of a ROM that stores an operation program containing a motion picture editing operation, described later, a RAM used as a work memory, and the like. The control section performs also operates as a motion picture reproducing section, an editing section, a deleting section, and a reproduction control section to control operations of the whole cellular phone 50.

The GPS receiver 76 calculates the latitude, longitude, and elevation of the present position and the exact present time from positioning information from a plurality of GPS satellites. The GPS receiver 76 then outputs these data to the control section 75.

Under the control of the control section 75, the image photographing section 77 controls photographing operations of a CCD 84 placed behind a photographing optical axis of an optical lens system 83 constituting the camera section 58. The image photographing section 77 then digitalizes image data obtained through photographing and then outputs the digitalized image data.

The image processing section 78 compresses image data obtained from the image photographing section 77, on the basis of, for example, the JPEG system. On the other hand, the image processing section 78 decompresses received image data to obtain the original image data in a bit map form.

The memory card 79 (storage section) is removably provided in the cellular phone 50 to store, for example, image data photographed by the cellular phone 50 or obtained through reception.

The LED section 80 is composed of a high-luminance white LED constituting the photographing light 59, and its driving circuit. The LED section 80 emits auxiliary light toward a subject to be photographed by the camera section 58, as required.

When the cellular phone receives a signal, the vibrator section 81 vibrates with a preset vibration pattern and a preset vibration intensity.

Each of the main display section 55 and the sub-display section 61 is composed of a reflection/transmission type color liquid crystal panel with a backlight. Turning the backlight on allows each of these sections to work as a transmission type liquid crystal. On the other hand, although it becomes a little difficult to see the image, turning the backlight off allows each of these sections to work as a reflection type liquid crystal using external light.

Although not shown, the hinge portion 51 has a mechanism for detecting the state in which the upper and lower housings 52 and 53 are opened or folded up. In a camera mode to which the cellular phone is shifted by operating a camera key 56a of the various keys 56 in order to use the camera section 58 to photograph an image, in the open state in which the upper housing 52 and the lower housing 53 are open as shown in FIG. 7A, described above, the control section 75 determines from information from this detecting mechanism that the user of the cellular phone 50 is photographing a person different from the user. The control section stops the display by the display section 61 and allows the main display section 55 to display a monitor image for the camera section 58. On this occasion, a set key 56b (position instructing section, first position instructing section, and second position instructing section) of the various keys 56 functions as a shutter key.

In contrast, in the folded state in which the upper housing 52 and the lower housing 53 are closed as shown in FIG. 7B, the control section 75 determines that the user of the cellular phone is photographing himself or herself. The control section 75 then stops the display by the main display section 55 and allows the sub-display section 61 to display a monitor image for the camera section 58. On this occasion, an image can be photographed by operating the shutter key 60.

Like the digital camera 1 according to the first embodiment, the cellular phone 50 enables not only still images but also motion pictures to be recorded and reproduced.

In this case, it is possible to store either still image data or motion picture data obtained through photographing, in the memory card 79 and to use the main display section 55 to arbitrarily reproduce and output the contents stored in the memory card 79 on the basis of a selection or instruction in the play mode. The data can also be transmitted to a receiver by being properly selected and set as a file attached to an e-mail.

Now, operations of the above embodiment will be described.

Basically, the control section 75 executes the processes shown below on the basis of a fixedly prestored program.

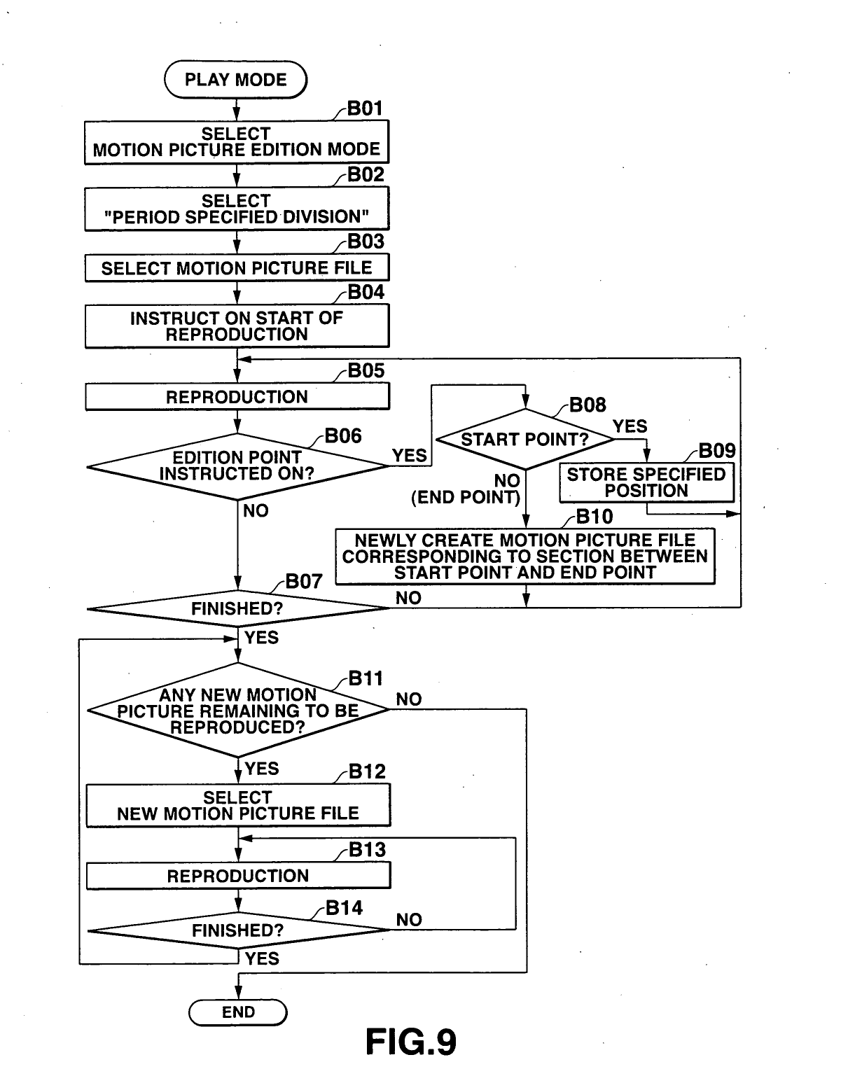

FIG. 9 shows the contents of processing executed in the play mode. First, in the play mode, the motion picture edition mode is selected (step B01).

At this time, the main display section 55 displays the “motion picture edition mode” together with other menu items, as shown in FIG. 4A, described above.

With the “motion picture edition mode” selected, the cross ring key of the various keys 56 and the set key 56b, located in the center of the cross ring key, are operated to establish the “motion picture edition mode”.

Items for editing methods any of which is selected to determine a specific manner of editing data in the motion picture edition mode are listed below as shown in FIG. 4B, described above.

In this case, the editing method can be selected from at least four items, for example, “time setting division (after)”, “time setting division (before)”, “period specified division”, and “division”. It is assumed that the “time setting division (after)” is selected, reversed, and blinked.

Here, the “time setting division (after)” is an editing method of setting an arbitrary edition point position in motion picture data as a start point to extract a portion succeeding the start point and extending over a temporal width arbitrarily set by the user, and storing the portion as another new motion picture data.

The “time setting division (before)” is an editing method of setting an arbitrary edition point position in motion picture data as an end point to extract a portion preceding the end point and extending over a temporal width arbitrarily set by the user, and storing the portion as another new motion picture data.

The “period specified division” is an editing method of setting two arbitrary edition point positions in motion picture data as a start and end points to extract a portion located between these two edition point positions, and storing the portion as another new motion picture data.

The “division” is an editing method of setting an arbitrary edition point position in motion picture data as a division point to extract portions preceding and succeeding the division point, and storing each portion as another new motion picture data.

The “period specified division” is selected from these editing methods and set (step B02). Motion picture data to be edited is selected (step B03). The appropriate operation is performed to instruct the reproduction of the data to be started (step B04).

In response to this instructing operation, the selected motion picture data is reproduced from its leading position (step B05). It is repeatedly determined whether or not an edition point position has been instructed on by, for example, operating the set key 56b (step B06) and whether or not all the motion picture data has been reproduced (step B07). Thus, the procedure waits until an edition point position is instructed on or the reproduction is finished.

Then, if an edition point position has been instructed on by operating the set key 56b, then it is determined whether or not the edition point position indicates the start point of motion picture data to be newly created (step B08).

If it is determined that the edition point position indicates the start point, the specified position is stored, for example, as temporal information (step B09). Then, the procedure returns to the process starting at the step B05.

If it is determined that the edition point position does not indicate the start point, then the start point has already been specified and the present edition point position indicates an end point. Accordingly, the motion picture data corresponding to the section between the start point stored in the step B09 in connection with the preceding instruction on the start point and the present end point is extracted (copied) and formed into another motion picture data. The resultant data is newly stored and saved in the memory card (step B10). The procedure then returns to the process starting at the step B05.

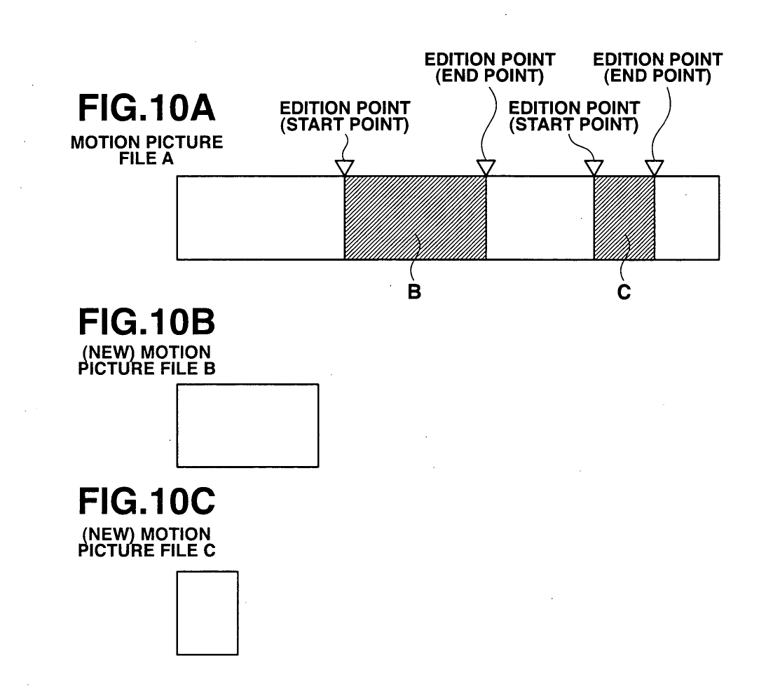

FIG. 10A illustrates an original motion picture data A to be edited. It is assumed that while this motion picture data is being reproduced, four edition point positions are instructed on as shown in the figure.

Accordingly, first, the contents corresponding to the section between the first specified edition point position as a start point and the second specified edition point position as an end point are extracted and stored as a new motion picture file B as shown in FIG. 10B.

Then, the contents corresponding to the section between third specified edition point position as a start point and the fourth specified edition point position as an end point are extracted and stored as a new motion picture file C as shown in FIG. 10C.

Once all the motion picture data has been reproduced, this is confirmed in step B07. Then, for the new motion picture data created in accordance with the instructions on the edition point positions during the reproduction of the original motion picture data, it is determined whether or not any data to be automatically reproduced (step B11) remains.

If during the reproduction of the motion picture data, there is at most one instruction on an edition point position given by operating the set key 56b, it is determined that there is no corresponding new motion picture data at this point. Thus, the series of processes are ended.

On the other hand, if it is determined in step B11 that new motion picture data to be automatically reproduced remains, one of the new motion picture data is selected in accordance with the order in which, for example, the edition point positions were instructed on (step B12).

Then, the selected new motion picture data is automatically reproduced (step B13). The procedure waits until the reproduction is finished (step B14). Once it is determined that the reproduction has been finished, the procedure returns to the process starting at the step B11.

All the motion picture data newly created in accordance with the instructions on the edition point positions are automatically repeatedly reproduced after the reproduction of the original motion picture data. Once all the new motion picture data has been automatically reproduced, this is confirmed in the step B11 to end the series of processes.

In this manner, new motion picture data different from the original motion picture data is created by operating the set key 56b of the various keys 56 to instruct on the start and end points of the extracted and copied section of the original motion picture data. Consequently, new motion picture data can be created merely by a simple operation of extracting a required length of data, without impairing the original motion picture data.

### THIRD EMBODIMENT

With reference to the drawings, description will be given below of a third embodiment in which the present invention is applied to a cellular phone with a camera function based on the CDMA system.

The external configuration of a cellular phone according to the embodiment of the present invention is basically the same as that shown in FIGS. 7A and 7B, described above. The configuration of an electronic circuit in the cellular phone is basically the same as that shown in FIG. 8, described above. The same parts are denoted by the same reference numerals and their illustrations and descriptions are omitted.

Now, operations of the above embodiment will be described.

Basically, the control section 75 executes the processes shown below on the basis of a fixedly prestored program.

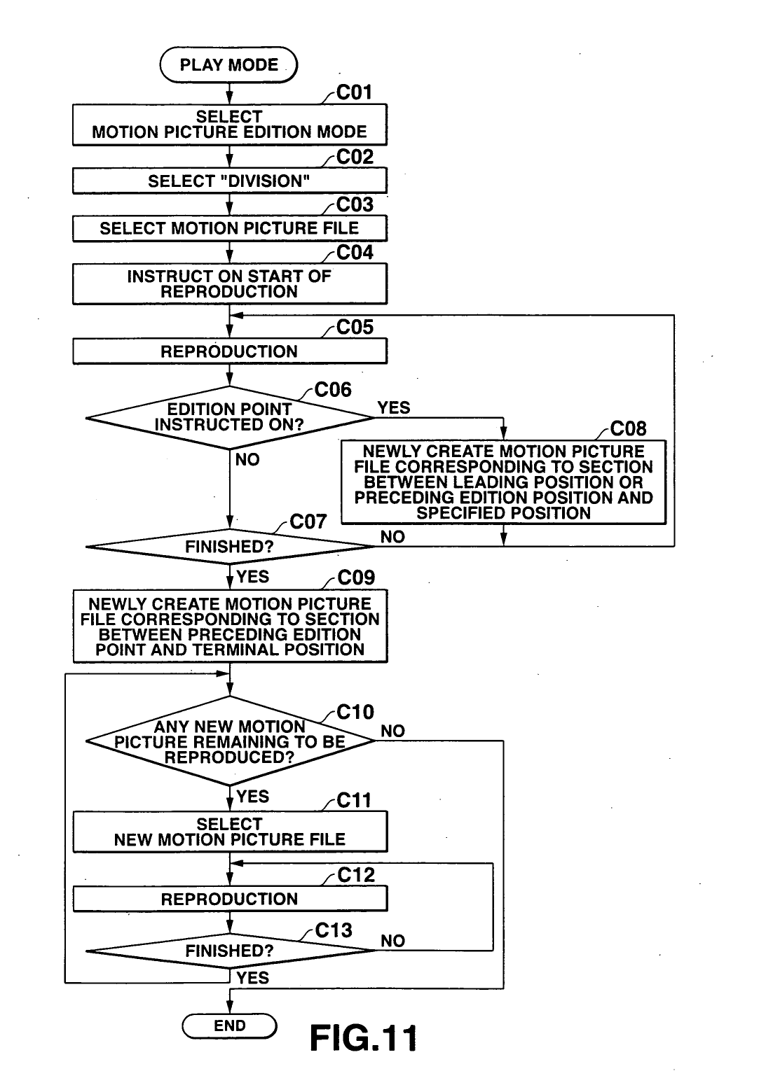

FIG. 11 shows the contents of processing executed in the play mode. First, in the play mode, the motion picture edition mode is selected (step C01).

At this time, the main display section 55 displays the “motion picture edition mode” together with other menu items, as shown in FIG. 4A, described above.

With the “motion picture edition mode” selected, the cross ring key of the various keys 56 and the set key 56b, located in the center of the cross ring key, are operated to establish the “motion picture edition mode”.

Items for editing methods any of which is selected to determine a specific manner of editing data in the motion picture edition mode are listed below as shown in FIG. 4B, described above.

In this case, the editing method can be selected from at least four items, for example, “time setting division (after)”, “time setting division (before)”, “period specified division”, and “division”. It is assumed that the “time setting division (after)” is selected, reversed, and blinked.

Here, the “time setting division (after)” is an editing method of setting an arbitrary edition point position in motion picture data as a start point to extract a portion succeeding the start point and extending over a temporal width arbitrarily set by the user, and storing the portion as another new motion picture data.

The “time setting division (before)” is an editing method of setting an arbitrary edition point position in motion picture data as an end point to extract a portion preceding the end point and extending over a temporal width arbitrarily set by the user, and storing the portion as another new motion picture data.

The “period specified division” is an editing method of setting two arbitrary edition point positions in motion picture data as a start and end points to extract a portion located between these two edition point positions, and storing the portion as another new motion picture data.

The “division” is an editing method of setting an arbitrary edition point position in motion picture data as a division point to extract portions preceding and succeeding the division point, and storing each portion as another new motion picture data.

The “division” is selected from these editing methods and set (step C02). Motion picture data to be edited is selected (step C03). The appropriate operation is performed to instruct the reproduction of the data to be started (step C04).

In response to this instructing operation, the selected motion picture data is reproduced from its leading position (step C05). It is repeatedly determined whether or not an edition point position has been instructed on by, for example, operating the set key 56b (step C06) and whether or not all the motion picture data has been reproduced (step C07). Thus, the procedure waits until an edition point position is instructed on or the reproduction is finished.

Then, if an edition point position has been instructed on by operating the set key 56b, then the edition point position is set as an end point to extract (copy) the motion picture data corresponding to the section between the leading position of the original motion picture data or the preceding specified edition point and the present edition point position. The extracted motion picture data is formed into another motion picture data, which is then newly stored and saved in the memory card 79 (step C08). The procedure returns to the process starting at the step C05.

Once all the motion picture data has been reproduced, this is confirmed in the step C07. Then, the motion picture data corresponding to the section between the last specified edition point position as a start point and the end position as an end point is extracted and formed into another motion picture data. The resultant data is newly stored and saved in the memory card 79 (step C09).

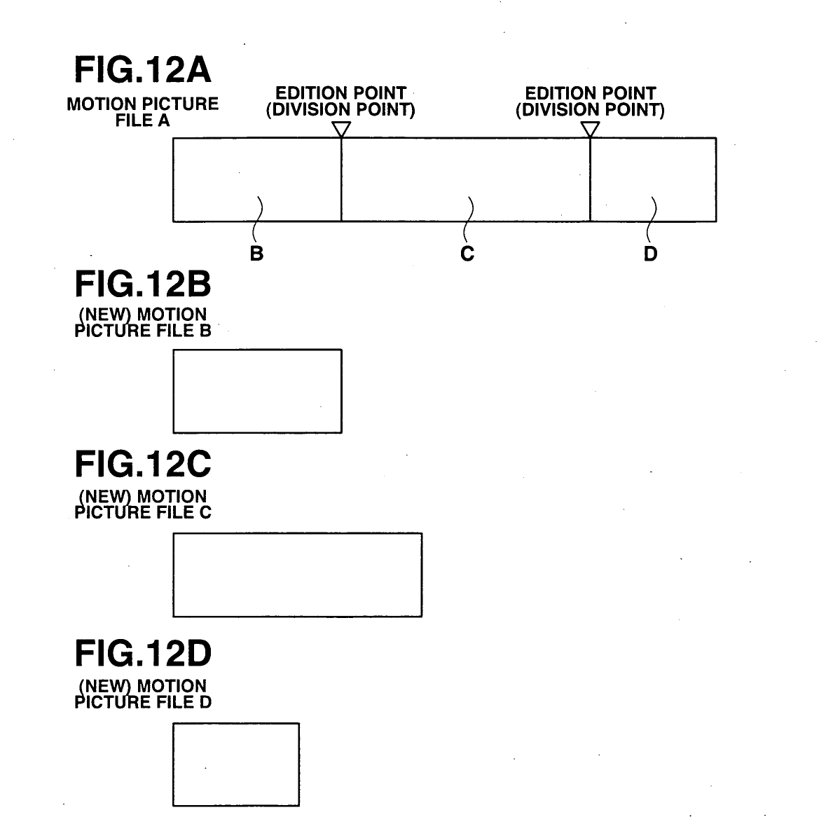

FIG. 12A illustrates an original motion picture data A to be edited. It is assumed that while this motion picture data is being reproduced, two edition point positions are instructed on as shown in the figure.

Accordingly, first, the first specified edition point position is set as an end point to extract the contents corresponding to the section between the leading position and the first specified edition point position and store the extracted contents as a new motion picture file B as shown in FIG. 12B.

Then, the second specified edition point position is set as an end point to extract the contents corresponding to the section between the first edition point position as a start point, which is instructed on immediately before the second specified edition point position, and the second specified edition point position and store the extracted contents as a new motion picture file C as shown in FIG. 12C.

Subsequently, once it is determined that all the original motion picture data A has been reproduced, the contents corresponding to the section between the second specified edition point position as a start point and the terminal of the motion picture data A as an end point are extracted and stored as a new motion picture file D as shown in FIG. 12D.

In this manner, all the original motion picture data is utilized to create new motion picture data using the divisions at the edition points. Then, for the new motion picture data created in accordance with the instructions on the edition point positions during the reproduction of the original motion picture data, it is determined whether or not any data to be automatically reproduced (step C11) remains.

If during the reproduction of the motion picture data, there is no instruction on an edition point position given by operating the set key 56b, it is determined that there is no corresponding new motion picture data at this point. Thus, the series of processes are ended.

On the other hand, if it is determined in step C11 that new motion picture data to be automatically reproduced remains, one of the new motion picture data is selected (step C12).

Then, the selected new motion picture data is automatically reproduced (step C13). The procedure waits until the reproduction is finished (step C14). Once it is determined that the reproduction has been finished, the procedure returns to the process starting at the step C11.

All the motion picture data newly created in accordance with the instructions on the edition point positions are automatically repeatedly reproduced after the reproduction of the original motion picture data. Once all the new motion picture data has been automatically reproduced, this is confirmed in the step C11 to end the series of processes.

In this manner, new motion picture data is created by operating the set key 56b of the various keys 56 to instruct on a division position as an edition point; the new motion picture data is composed of two portions which precede and succeed the division point, respectively, and into which the original motion picture data has been divided at the division position. Consequently, new motion picture data can be created only by a simple operation without impairing the original motion picture data.

In each of the first to third embodiments, edition point positions are instructed on in the motion picture edition mode to simply create new motion picture data different from the original motion picture data. However, after new motion picture data has been created, the original motion picture data may be deleted after getting the user's permission to delete the original motion picture data by, for example, displaying a guide message on the display section to prompt the user to operate the corresponding key to input the permission.

When the original motion picture is thus automatically deleted when no longer required, particularly if the equipment has a limited capacity to store motion picture data, the storage capacity can be effectively used.

In particular, with the method of dividing the original motion picture data using an edition point as a base point as described in the third embodiment, the original motion picture data can be easily restored by combining together the motion picture data newly created by division. Consequently, if the original motion picture data is deleted after an editing operation, nothing is lost and the data can be more effectively used.

In the first embodiment, the present invention is applied to the digital camera. In the second and third embodiments, the present invention is applied to the cellular phone with the camera function. However, the present invention is not limited to these aspects. The present invention is applicable to any equipment such as a PDA or a handheld personal computer which can reproduce motion picture data.

Further, the present invention is not limited to the above embodiments. Many variations may be made to the embodiments without departing from the spirit of the present invention.

Moreover, the above embodiments include inventions at various levels. Various inventions can thus be extracted by properly combining a plurality of disclosed constitution requirements together. For example, even if any of all the constitution requirements shown in the embodiments are deleted, the configuration free from these constitution requirements can be extracted as an invention provided that it can solve at least one of the objects described in Summary of the invention and can produce at least one of the effects also described in Summary of the invention.

What is claimed is:

1. An apparatus for editing a motion picture, the apparatus comprising:
a storage section which stores motion picture data;
a display section which displays an image;
a motion picture reproducing section which reproduces the motion picture data stored in the storage section to display the reproduced data on the display section;
a position instructing section which instructs on an edition point position at an arbitrary time while the motion picture reproducing section is reproducing a motion picture; and
an editing section which uses the edition point position instructed on by the position instructing section as a base point to store an amount of the motion picture data corresponding to a predetermined time in the storage section as new motion picture data.

2. The apparatus for editing a motion picture according to claim 1, wherein the editing section stores an amount of the motion picture data which corresponds to a predetermined time before or after the edition point position as a base point on a time axis.

3. The apparatus for editing a motion picture according to claim 1, further comprising a time instructing section which instructs a time value for the predetermined time.

4. The apparatus for editing a motion picture according to claim 2, further comprising a time instructing section which instructs a time value for the predetermined time.

5. An apparatus for editing a motion picture, the apparatus comprising:
a storage section which stores motion picture data;
a display section which displays an image;
a motion picture reproducing section which reproduces the motion picture data stored in the storage section to display the reproduced data on the display section;
a first position instructing section which instructs on a first edition point position at an arbitrary time while the motion picture reproducing section is reproducing a motion picture;
a second position instructing section which operates after the instruction has been given by the first position instructing section, to instruct on a second edition point position at an arbitrary time; and
an editing section which stores a part of the motion picture data in the storage section as new motion picture data on the basis of the first and second edition point positions instructed on by the first and second position instructing sections, respectively.

6. An apparatus for editing a motion picture, the apparatus comprising:
a storage section which stores motion picture data:
a display section which displays an image;
a motion picture reproducing section which reproduces the motion picture data stored in the storage section to display the reproduced data on the display section;
a position instructing section which instructs on an edition point position at an arbitrary time while the motion picture reproducing section is reproducing a motion picture; and
an editing section which divides the motion picture data on the basis of the edition point position instructed on by the position instructing section to store each of the motion picture data preceding the edition point position and the motion picture data succeeding the edition point position in the storage section as new motion picture data.

7. The apparatus for editing a motion picture according to claim 1, further comprising a deleting section which operates after the editing section has stored the new motion picture data in the storage section, to get permission to delete the original motion picture data and then automatically delete the original motion picture data from the storage section.

8. The apparatus for editing a motion picture according to claim 5, further comprising a deleting section which operates after the editing section has stored the new motion picture data in the storage section, to get permission to delete the original motion picture data and then automatically delete the original motion picture data from the storage section.

9. The apparatus for editing a motion picture according to claim 6, further comprising a deleting section which operates after the editing section has stored the new motion picture data in the storage section, to get permission to delete the original motion picture data and then automatically delete the original motion picture data from the storage section.

10. The apparatus for editing a motion picture according to claim 1, further comprising a reproduction control section which operates after the motion picture reproducing section has reproduced the motion picture data, to reproduce the motion picture data newly stored by the editing section in the storage section to display the reproduced motion picture data on the display section.

11. The apparatus for editing a motion picture according to claim 5, further comprising a reproduction control section which operates after the motion picture reproducing section has reproduced the motion picture data, to reproduce the motion picture data newly stored by the editing section in the storage section to display the reproduced motion picture data on the display section.

12. The apparatus for editing a motion picture according to claim 6, further comprising a reproduction control section which operates after the motion picture reproducing section has reproduced the motion picture data, to reproduce the motion picture data newly stored by the editing section in the storage section to display the reproduced motion picture data on the display section.

13. A method for editing a motion picture, the method comprising:
a motion picture reproducing step of reading and reproducing image data stored in a storage section to display the reproduced data on a display section;
a position instructing step of instructing on an edition point position at an arbitrary time while a motion picture is being reproduced during the motion picture reproducing step; and
an editing step of using the edition point position instructed on in the position instructing step as a base point to store an amount of the motion picture data corresponding to a predetermined time in the storage section as new motion picture data.

14. A method for editing a motion picture, the method comprising:
a motion picture reproducing step of reading and reproducing image data stored in a storage section to display the reproduced data on a display section;
a first position instructing step of instructing on a first edition point position at an arbitrary time while a motion picture is being reproduced during the motion picture reproducing step;
a second position instructing step of, after the instruction has been given by the first position instructing section, instructing on a second edition point position at an arbitrary time; and
an editing step of storing a part of the motion picture data in the storage section as new motion picture data on the basis of the first and second edition point positions instructed on by the first and second position instructing sections, respectively.

15. A method for editing a motion picture, the method comprising:
a motion picture reproducing step of reading and reproducing image data stored in a storage section to display the reproduced data on a display section;
a position instructing step of instructing on an edition point position at an arbitrary time while a motion picture is being reproduced during the motion picture reproducing step; and
an editing step of dividing the motion picture data on the basis of the edition point position instructed on in the position instructing step to store each of the motion picture data preceding the edition point position and the motion picture data succeeding the edition point position in the storage section as new motion picture data.

16. A recording medium in which a computer executable program is recorded, the recording medium comprising:
a motion picture reproducing step of reading and reproducing image data stored in a storage section to display the reproduced data on a display section;
a position instructing step of instructing on an edition point position at an arbitrary time while a motion picture is being reproduced during the motion picture reproducing step; and
an editing step of using the edition point position instructed on in the position instructing step as a base point to store an amount of the motion picture data corresponding to a predetermined time in the storage section as new motion picture data.

17. A recording medium in which a computer executable program is recorded, the recording medium comprising:
a motion picture reproducing step of reading and reproducing image data stored in a storage section to display the reproduced data on a display section;
a first position instructing step of instructing on a first edition point position at an arbitrary time while a motion picture is being reproduced during the motion picture reproducing step;
a second position instructing step of, after the instruction has been given by the first position instructing section, instructing on a second edition point position at an arbitrary time; and
an editing step of storing a part of the motion picture data in the storage section as new motion picture data on the basis of the first and second edition point positions instructed on by the first and second position instructing sections, respectively.

18. A recording medium in which a computer executable program is recorded, the recording medium comprising:
a motion picture reproducing step of reading and reproducing image data stored in a storage section to display the reproduced data on a display section;
a position instructing step of instructing on an edition point position at an arbitrary time while a motion picture is being reproduced during the motion picture reproducing step; and
an editing step of dividing the motion picture data on the basis of the edition point position instructed on in the position instructing step to store each of the motion picture data preceding the edition point position and the motion picture data succeeding the edition point position in the storage section as new motion picture data.
